(19) United States
(12) Patent Application Publication
(10) Pub. No.: US 2015/0058196 A1
(43) Pub. Date: Feb. 26, 2015

(54) Systems and Methods for Managing Trade Exposure

(71) Applicant: FNY TECHNOLOGIES LLC, New York, NY (US)

(72) Inventors: Sal Martorano, Marlboro, NJ (US); Brandt Mandia, Staten Island, NY (US)

(21) Appl. No.: 14/466,134

(22) Filed: Aug. 22, 2014

Related U.S. Application Data
(60) Provisional application No. 61/869,276, filed on Aug. 23, 2013.

(51) Int. Cl. G06Q 40/04

(52) U.S. Cl. CPC G06Q 40/04
USPC 705/37

(57) ABSTRACT

Methods and supporting systems for updating an order type within a trade execution server for a single trading entity having multiple independent traders includes receiving, via an electronic network, a trade order for a hard-to-borrow security from multiple independent traders, and, periodically calculating an overall net position for the hard-to-borrow security for a single entity for which the traders are operating. If the trade order is a sell-long order and the net position for the corresponding security is net short, the trade order is converted to a sell-short order, and if the trade order is a sell-short order and the net position is net long, the trade order is converted to a sell-long order. The converted trade order is then transmitted to a trade execution engine for market execution.

### CROSS REFERENCE TO RELATED APPLICATIONS

This application claims priority to and the benefit of U.S. Provisional Patent Application Ser. No. 61/869,276, filed on Aug. 23, 2013, the entire disclosure of which is incorporated herein.

### FIELD OF THE INVENTION

The invention relates generally to techniques for managing trades in an equities market, and, more specifically, to methods and supporting systems for maintaining a centralized control of short and long orders among independent traders acting on behalf of a single firm, and ensuring shares are located to cover short orders.

### BACKGROUND

Historically, equity traders have bought and sold securities for individual clients using the clients' funds. Traders within a large brokerage house essentially operated using separate pools of capital, and often based their trading on a central research group that offered advice on which equities or sectors provided opportunities for profit.

More recently, hedge funds emerged as a means for accredited investors to invest in private, actively managed investment funds. Unlike traditional mutual funds, hedge funds invest in a diverse range of markets, investment instruments, and strategies, including short sales.

Because hedge funds are not sold to the general public or retail investors, the funds and their managers have historically been exempt from some of the regulations that governs other funds and investment managers with regard to how the fund may be structured and how investment strategies and techniques are employed. Recent regulations passed in the United States and Europe were intended to increase control and government oversight of hedge funds and eliminate certain regulatory gaps.

One such regulation is referred to as Regulation SHO (or “REG SHO”) which established “locate” and “close-out” standards that are primarily aimed at preventing the opportunity for unethical traders to engage in naked short selling practices. For trading entities organized as hedge funds and having multiple independent traders placing orders on behalf of a single firm, REG SHO requires the firm/hedge fund to maintain a centralized position monitoring and execution system that meets the share location rules for each trade.

Therefore, what is needed, are methods and supporting systems to aggregate and manage short and long trades across independent traders who may be taking opposite positions on a single equity, even though they are trading under the same firm/fund umbrella, and do so in a way that meets the REG SHO rules.

### SUMMARY OF THE INVENTION

Various implementations of the invention provide methods and supporting systems for allowing certain trades to be presented to the market that, absent such techniques, would otherwise be cancelled. For example, for thinly traded securities and other securities that are deemed “hard to borrow” short sale orders may be difficult to fill given a certain net position for that security across an entity. This is especially true in cases where multiple traders are acting independently but trading through and on behalf of a single entity that needs to meet certain regulations.

Therefore, in a first aspect, a method for updating an order type within a trade execution server for a single trading entity having multiple independent traders includes receiving, via an electronic network, a trade order for a hard-to-borrow security from one of the multiple independent traders, and, periodically and in some cases independently from receipt of the trade, calculating, across multiple independent traders, an overall net position for the hard-to-borrow security for a single entity for which the traders are operating. If the trade order is a sell-long order and the net position for the corresponding security is net short, the trade order is converted to a sell-short order, and if the trade order is a sell-short order and the net position is net long, the trade order is converted to a sell-long order. The converted trade order is then transmitted to a trade execution engine for market execution.

In some embodiments, the single entity is one of a hedge fund, a mutual fund, or a brokerage firm. The hard to borrow security may be an equity that is thinly traded or otherwise hard to borrow to cover short positions. Calculating the overall net position may be performed daily or on an intra-day periodicity, such as hourly or after each trade clears. In some instances, the multiple independent traders manage independent pools of investible capital on behalf of the single entity.

In certain cases, if the trade order is a sell-long order and the net position for the corresponding security is net short and the net short position does not fully cover the sell-long position, a portion of the trade order is converted into a sell-short order based on the net short position and a second sell-long order may be initiated to cover then difference between the sell-long order and the sell-short order. In other cases, if the trade order is a sell-short order and the net position for the corresponding security is net long and the net long position does not fully cover the sell-short position, a portion of the trade order may be converted into a sell-long order based on the net long position and a second sell-short order is initiated to cover the difference between the sell-short order and the sell-long order.

In another aspect, a system for updating an order type within a trade execution server for a single trading entity having multiple independent traders includes a memory for storing computer-executable instructions to update order types based on a net position for a security a processor for executing the stored instructions, that when executed implement an execution server application. The application receives trade orders for a hard-to-borrow security from one of the multiple independent traders and calculates, across all of the multiple independent traders, an overall net position for the hard-to-borrow security. In some instances, the net position may be calculated by a separate application or server and transmitted to the server application for use to determine if a trade order is to be modified. If the trade order is a sell-long order and the net position for the corresponding security is net short, the trade order is converted to a sell-short order, and of the trade order is a sell-short order and the net position is net long, the trade order is converted to a sell-long order. The converted trade order is then transmitted to a trade execution engine for market execution.

In some embodiments, the single entity is one of a hedge fund, a mutual fund, or a brokerage firm. The hard to borrow security may be an equity that is thinly traded or otherwise hard to borrow to cover short positions. Calculating the overall net position may be performed daily or on an intra-day periodicity, such as hourly or after each trade clears. In some instances, the multiple independent traders manage independent pools of investible capital on behalf of the single entity.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention.

FIG. 1 illustrates a general environment in which the systems and techniques of various embodiments of the invention operate.

FIG. 2 illustrates the arrangement of devices for consolidating trade orders to determine overall positions in accordance with various embodiments of the invention.

FIG. 3 is a flow chart illustrating a method to implement the techniques for managing trade exposure according to one embodiment of the invention.

FIG. 4 is a flow chart illustrating one example of data and messaging flows for managing trade exposure according to one embodiment of the invention.

FIG. 5 is a schematic of a system for managing trade exposure according to one embodiment of the invention.

### DESCRIPTION OF THE INVENTION

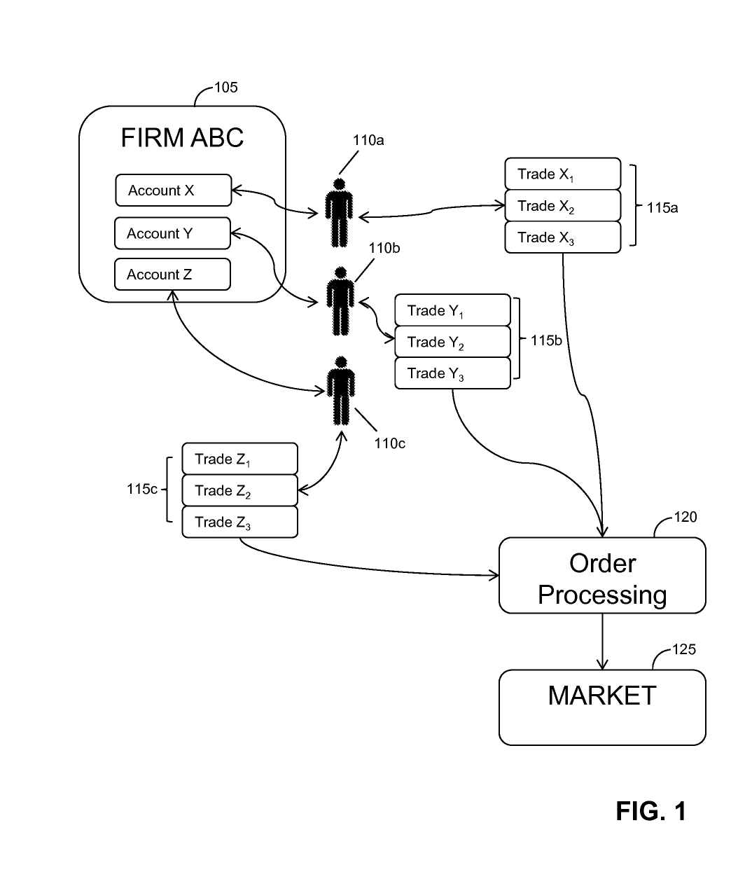

FIG. 1 illustrates one possible operating environment in which the techniques and supporting systems of the invention may be implemented. A trading entity, 105 operates as a single trading entity, but may employ numerous traders 110a, 110b and 110c (generally 110), each trading on behalf of the entity 105 but using separate accounts (Account X, Account Y and Account Z, for example). In this embodiment, three traders and accounts are shown, but any number of individual traders and accounts may be used. Each trader 110 generates one or more trades 115 based on that trader's analysis and information. Because each trader 110 may have a different view of the market generally or a particular position specifically, opposing trades (Trade X₁ and Trade Z₃, for example), may be placed simultaneously on behalf of different traders 110, but ultimately for the same entity 105. For example, one trader 110a may believe that the current price for Microsoft (MSFT) has reached a peak, or that certain economic indicators hint at a softening in the technology sector, and therefore the trader 110a may “short” MSFT. Conversely, another trader 110b working for the same entity 105 may believe that a new product offering will boost sales, and therefore Microsoft's share price will increase over time, and place orders to buy shares at the current price. Conventional practices would have each trade 115 processing individually through an order processing step 120 and on to the market 125 to be filled.

As part of the fulfillment process, the entity 105 may “net” its current balance for particular positions by matching its short sale positions with long positions in the same asset. Therefore, at the entity level, the entity may be “net short” (e.g., its short positions outnumber the long positions) or “net long” (e.g., its short positions outnumber the long positions). In order to “cover” a net short position, the entity may either cover the position with shares in its own inventory (long positions) or “borrow” shares of the security from a broker who typically keeps shares in inventory. However, certain assets and asset classes are deemed to be “hard to borrow” because it is in short supply, or there is exceptionally low or high volatility in its trading. Therefore, for these hart to borrow securities, neither approach may be possible.

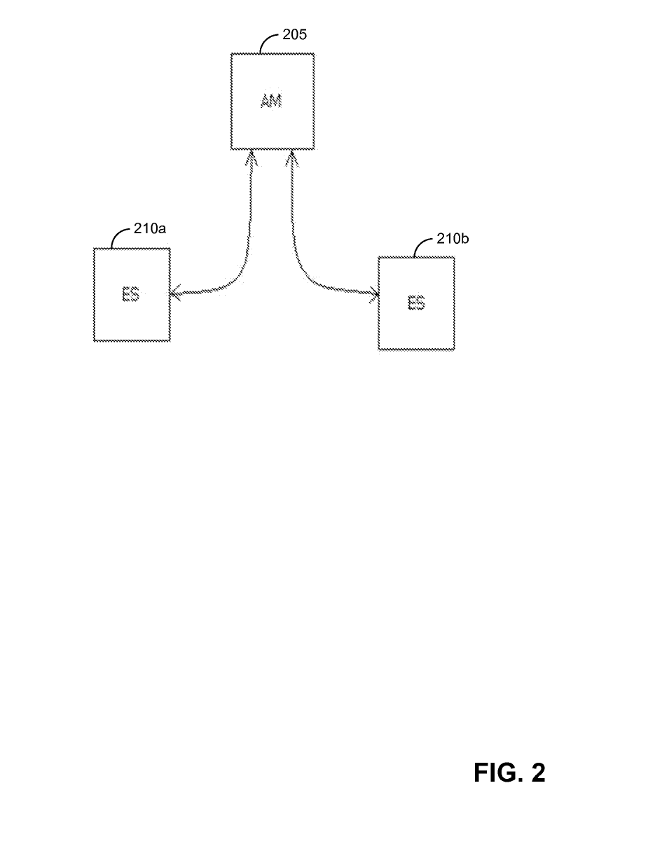

FIG. 2 illustrates one embodiment of a collection of operational servers for implementing the techniques described herein. An Aggregation Module (AM) 205 maintains a net equities position and located shares amount in real time for multiple independent business units associated with a specific fund, firm or Broker Dealer. The term Aggregation Unit (or “AU”) is used herein to describe the single entity 105—whether it be a single firm or fund—across which the AM is consolidating orders. The aggregation can be done across multiple Execution Servers (ES) 210 or single Execution Server—each being attributed to an individual trader, desk or business unit within a single AU 105. As such, the AM 205 knows the actual per-symbol position across the AU, and can make any necessary adjustments to the order type (e.g., changing a sell short order to a long sell order, or vice versa). Furthermore, the AM 205 can incorporate the validation of located positions for short orders on Hard-To-Borrow equities during the order entry to stay compliant to the regulation(s).

At a summary level, the AM 205 calculates the real-time net position and the located shares amount for all securities being traded across the AU 105. As orders originate from numerous independent accounts (e.g., traders operating independently within the AU), the AM 205 maintains a grouping that attributes multiple accounts to a single AU 105, which can then be reported or displayed in real time.

More specifically, each ES 210a and 210b identifies to its associated AM 205 which AUs 105 it is responsible for and the listing of accounts associated with each AUs. At the start of each trading period (typically a trading day) the Start of Day Positions are determined. During the trading period (intraday) each ES 210 sends all order status messages (Open, Cancel, Reject, Execution) to the AM 205 which calculates real-time net positions per trading symbol. Net position, as used herein, refers to the total position across an AU 105. For example, if trader 1 110a is long 500 shares of MSFT, and trader 2 110b is short 250 shares of MSFT, and both traders are attributed to the same AU, the net position for that AU is long 250. Alternatively, if both traders are both short 150 shares of MSFT, the net position is short 300.

As the net position for a symbol changes at the AM 205, the AM 205 sends a new calculated net position value to each corresponding ES pool(s) 210 associated with the AM 205 by broadcasting the Net Position and the Net Shares Located to each ES 210 in single message per AU 105. Each ES 210 receives the broadcasted information and uses it for locate validation purposes, as well as flipping of the order side when appropriate, as described in greater detail below.

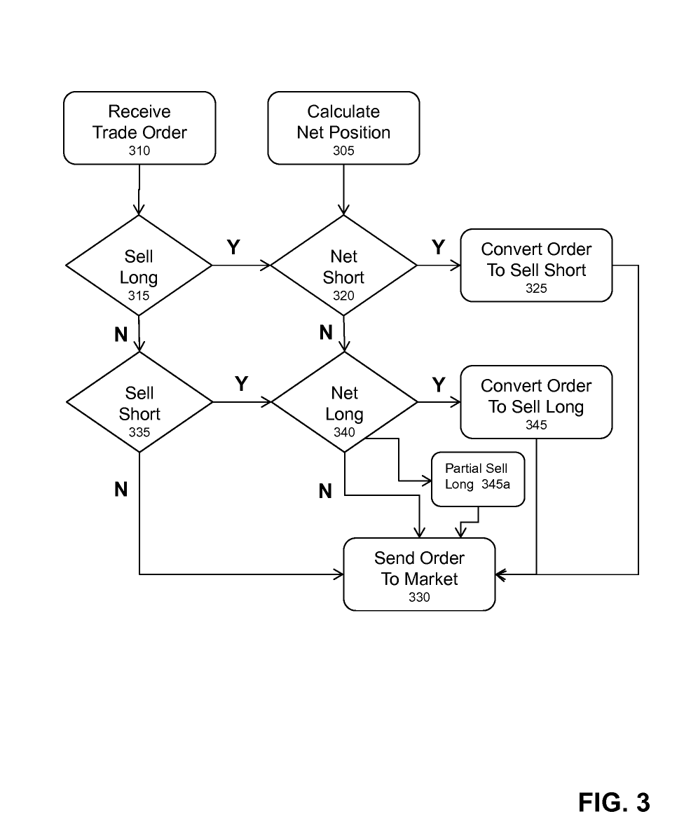

FIG. 3 is a flow chart illustrating one possible embodiment of a process for managing and processing trades, that is particularly useful when processing trades for hard to borrow securities. As described above, a net position is calculated (305) for an entity. The calculation can occur at any periodicity (daily, hourly, per order, etc.), but in most implementations occurs at least daily. A trade order is received (310) from a trader operating on behalf of an entity, and checked to determine whether the trade is a Sell Long trade (315). If so, the net position for the asset being traded is checked to determine of the overall position is a net short position (320). If the trade is a sell long order and the net position is short, the order is converted to a sell short order (325) and sent to the market for fulfillment (330).

Alternatively, if the order is a sell short order (335) and the net position is net long (340), the order is converted to a sell long order (345) before being sent to the market for fulfillment (330). In some instances depending, for example, on the size of the short order and located quantity (which may not fully cover the order), the order may be split into both a long sell (345a) and a short sell order before being sent to market for fulfillment (330). More specifically, if the trade order is a sell-long order and the net position for the corresponding security is net short and the net short position does not fully cover the sell-long position, a portion of the trade order is converted into a sell-short order based on the net short position and a second sell-long order may be initiated to cover then difference between the sell-long order and the sell-short order. Conversely, if the trade order is a sell-short order and the net position for the corresponding security is net long and the net long position does not fully cover the sell-short position, a portion of the trade order may be converted into a sell-long order based on the net long position and a second sell-short order is initiated to cover the difference between the sell-short order and the sell-long order.

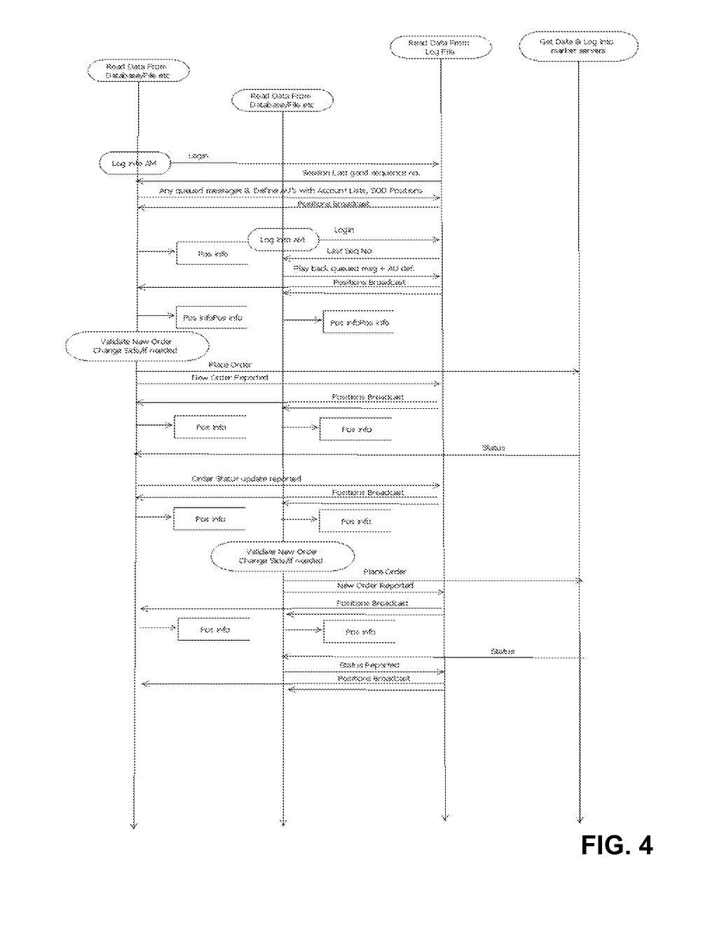

FIG. 4 illustrates a more detailed data flow among the various components of the system, showing how the ES 210 initiates a session with an AM 205, and how the New Order, Order Status, and Positions data change events are communicated and how they are used for validation of the next New Order.

A connection begins with the AM opening a TCP/IP socket to the ES and sending a Login Message that specifies the next sequence number the AM wants to receive upon connection, or 0 to start receiving the most recent message. The ES responds with a Login Accepted Message that contains the sequence number of the next message to be sent and begins sending Order Status messages to the AM. The connection continues until the TCP/IP socket is broken. Messages from the ES to the AM do not need to contain an explicit sequence number; instead both ES and AM compute the sequence number locally by counting messages as they go. The sequence number of the first message from the ES to the AM is always 1 and is reset at the beginning of each trading period.

Heartbeat (HB) messages may be utilized to quickly detect link failures. For example, the AM and/or the ES may send a HB message after a specified period of time (e.g., 1 second) has passed since the last message was sent or received. If either the AM or ES do not receive any message from each other for more than some other longer period (e.g., 10 seconds) the link may assumed to be broken.

To calculate the Net Position per AU/Account/Firm per symbol, the AU uses the following formula:

Net Position=Start of Day Position+Total BUY Executed shares−Total SELL LONG Executed shares−Total SELL SHORT Executed shares−Total SELL LONG Open shares−Total SELL SHORT Open shares

Simultaneously, the AM calculates the Net Located Shares per AU per symbol as:

Net Shares Located=Start of Day shares located+Total shares located for the Day

If the Net Position is calculated as negative, it is subtracted from Net Located value. In instances in which the AU can carry forward unused located shares from a previous trading period to the next, the start of day located shares is included in the above calculations.

In certain embodiments, the methodology facilitates the updating of an order type at the ES (e.g., from short to long, or vice versa) depending on the overall Net Position calculated by the AM. Upon receiving a sell order, the ES checks the overall net position to determine if the order type (Short or Long) is appropriate, and if not the order type is changed. For example, if the AU is flat or short SYM1, and a sell-long order is entered for 500 shares, the ES converts the trade to a sell-short order before sending the order to the market. Conversely, if the AU is long 5000 shares of SYM2 and a sell-short order is entered for 2500 shares, the ES determines that the order quantity of the trade is less than the AU's net long position, so the ES converts the order to a sell-long order. While it may be possible to break certain orders into subordinate orders, in certain embodiments the system will convert an entire order from sell-long to sell-short. For example, if the AU is long 50,000 shares of ABC and a sell long order is entered for 75,000, the entire order is converted to a sell-short, even if only 25,000 shares are not covered by the existing AU position.

Certain equities are actively traded and, because of the fluidity of the market for these equities they are considered “easy to borrow” and are listed on an easy-to-borrow list. These equities are relatively easy to “locate” or borrow in order to cover short positions—a requirement of REG SHO. However, for equities and other instruments that are deemed “hard to borrow” (HTB), orders for these equities are tagged accordingly, and the ES must ensure that the net shares located for the equity exceeds the share quantity of any sell short order (e.g., located shares>short sell quantity). If the number of located shares does not meet or exceed the number of short sell shares, the entire order is rejected, and the rejection is communicated to the AM.

In some instances, located shares attributed to an order may be reassigned to a new short sell order if the order for which the shares were originally located has cleared or been balanced by a matching sell long order. The locates are deemed available for the entire AU, no matter which trader entered the original located shares.

It is understood that the methods and systems described herein may contain software and hardware connected to the Internet via a network. Computing devices are capable of communicating with each other via the Internet, and it should be appreciated that the various functionalities of the components may be implemented on any number of devices.

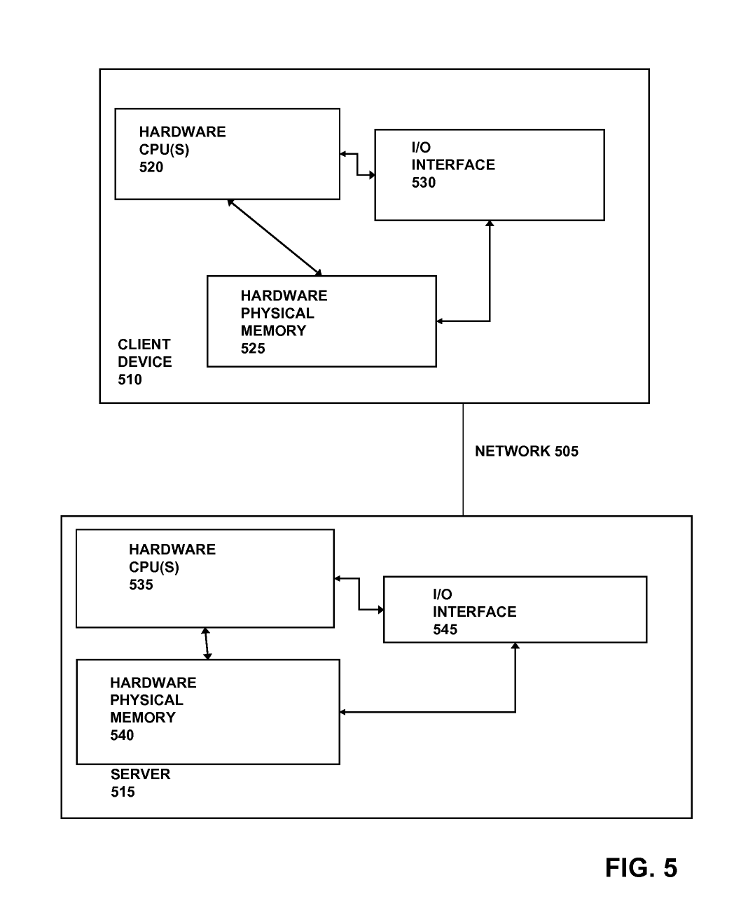

Referring to FIG. 5, a communications network 505 generally connects a client device 510 on which the user interacts with a trading application with a server 515, and in the case of peer to peer communications, connects two peers. The communication may take place via any media such as standard telephone lines, LAN or WAN links (e.g., T1, T3, 56 kb, X.25), broadband connections (ISDN, Frame Relay, ATM), wireless links (802.11, Bluetooth, etc.), cellular, cellular data (e.g., 4GLTE) and so on. Preferably, the network can carry TCP/IP protocol communications, and HTTP/HTTPS requests made by a web browser and the connection may be made between the peers and communicated over such TCP/IP networks.

The type of network is not a limitation, however, and any suitable network may be used. Non-limiting examples of networks that can serve as or be part of the communications network include a wireless or wired Ethernet-based intranet, a local or wide-area network (LAN or WAN), and/or the global communications network known as the Internet, which may accommodate many different communications media and protocols.

Client device 505 and server(s) 510 may be implemented in any suitable way. FIG. 5 illustrates an exemplary architecture for a client device 505 and a server 510 that may be used in some embodiments. The client device 505 may include hardware central processing unit(s) (CPU) 520, operatively connected to hardware/physical memory 525 and input/output (I/O) interface 530. Exemplary server 515 similarly comprises hardware CPU(s) 535, operatively connected to hardware/physical memory 540 and input/output (I/O) interface 545. Hardware/physical memory may include volatile and/or non-volatile memory. The memory may store one or more instructions to program the CPU to perform any of the functions described herein. The memory may also store one or more application programs.

Exemplary client device 510 and exemplary server 515 may have one or more input and output devices. These devices can be used, among other things, to present a user interface and/or communicate (e.g., via a network) with other devices or computers. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Although examples provided herein may have described the servers as residing on separate computers, it should be appreciated that the functionality of these components can be implemented on a single computer, or on any larger number of computers in a distributed fashion.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only. The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above. The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

In some embodiments the functions may be implemented as computer instructions stored in portions of a computer's random access memory to provide control logic that affects the processes described above. In such an embodiment, the program may be written in any one of a number of high-level languages, such as FORTRAN, PASCAL, C, C++, C#, Java, javascript, Tcl, or BASIC. Further, the program can be written in a script, macro, or functionality embedded in commercially available software, such as EXCEL or VISUAL BASIC. Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, “computer-readable program means” such as a floppy disk, a hard disk, an optical disk, a magnetic tape, a PROM, an EPROM, or CD-ROM.

Variations, modifications, and other implementations of what is described herein will occur to those of ordinary skill in the art without departing from the spirit and the scope of the invention as claimed. The computer system may include a general purpose computing device in the form of a computer including a processing unit, a system memory, and a system bus that couples various system components including the system memory to the processing unit.

What is claimed is:

1. A method for updating an order type within a trade execution server for a single trading entity having multiple independent traders, the method comprising:
receiving via an electronic network a trade order for a hard-to-borrow security from one of the multiple independent traders;
calculating, across a plurality of the multiple independent traders, an overall net position for the hard-to-borrow security for a single entity;
if the trade order is a sell-long order and the net position for the corresponding security is net short, converting the trade order to a sell-short order, and if the trade order is a sell-short order and the net position is net long, converting the trade order to a sell-long order; and
transmitting the converted trade order to a trade execution engine for market execution.

2. The method of claim 1 wherein the single entity comprises a hedge fund.

3. The method of claim 1 wherein the hard to borrow security comprises an equity.

4. The method of claim 3 wherein the equity is thinly traded.

5. The method of claim 1 wherein calculating the overall net position is performed daily.

6. The method of claim 1 wherein calculating the overall net position is performed on an intra-day periodicity.

7. The method of claim 1 wherein the multiple independent traders manage independent pools of investible capital on behalf of the single entity.

8. The method of claim 1 wherein the trade order is a sell-long order and the net position for the corresponding security is net short and the net short position does not fully cover the sell-long position, converting a portion of the trade order into a sell-short order based on the net short position and initiating a second sell-long order to cover a difference between the sell-long order and the sell-short order.

9. The method of claim 1 wherein the trade order is a sell-short order and the net position for the corresponding security is net long and the net long position does not fully cover the sell-short position, converting a portion of the trade order into a sell-long order based on the net long position and initiating a second sell-short order to cover a difference between the sell-short order and the sell-long order.

10. A system for updating an order type within a trade execution server for a single trading entity having multiple independent traders, the system comprising:
a memory for storing computer-executable instructions to update order types based on a net position for a security; and
a processor for executing the stored instructions, that when executed implement an execution server application for:
receiving a trade order for a hard-to-borrow security from one of the multiple independent traders;
calculating, across all of the multiple independent traders, an overall net position for the hard-to-borrow security;
if the trade order is a sell-long order and the net position for the corresponding security is net short, converting the trade order to a sell-short order, and of the trade order is a sell-short order and the net position is net long, converting the trade order to a sell-long order; and
transmitting the converted trade order to a trade execution engine for market execution.

11. The system of claim 9 wherein the single entity comprises a hedge fund.

12. The system of claim 9 wherein the hard to borrow security comprises an equity.

13. The system of claim 12 wherein the equity is thinly traded.

14. The system of claim 9 wherein calculating the overall net position is performed daily.

15. The system of claim 9 wherein calculating the overall net position is performed on an intra-day periodicity.

16. The system of claim 9 wherein the multiple independent traders manage independent pools of investible capital on behalf of the single entity.

17. The system of claim 9 wherein the trade order is a sell-long order and the net position for the corresponding security is net short and the net short position does not fully cover the sell-long position, converting a portion of the trade order into a sell-short order based on the net short position and initiating a second sell-long order to cover a difference between the sell-long order and the sell-short order.

18. The system of claim 9 wherein the trade order is a sell-short order and the net position for the corresponding security is net long and the net long position does not fully cover the sell-short position, converting a portion of the trade order into a sell-long order based on the net long position and initiating a second sell-short order to cover a difference between the sell-short order and the sell-long order.
